(19) United States
(12) Patent Application Publication
(10) Pub. No.: US 2008/0215590 A1
(43) Pub. Date: Sep. 4, 2008

(54) SYSTEM AND METHOD FOR ASSESSING THE IMPORTANCE OF A WEB LINK

(76) Inventors: Mary Rose Thai, Phoenix, AZ (US); Austin Lemme, Scottsdale, AZ (US); Jeff Hollowell, Gilbert, AZ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/840,885

(22) Filed: Aug. 17, 2007

Related U.S. Application Data
(60) Provisional application No. 60/838,774, filed on Aug. 18, 2006.

(51) Int. Cl. G06F 17/30

(52) U.S. Cl. 707/10; 707/E17.032

(57) ABSTRACT

A system and method for determining the most relevant web links to a destination web page is disclosed. The method generates a link value for a linking web page by analyzing the position of the link to the destination web page, the number of links to the destination web page, the number of links to competitors of the destintion web page, and a universal significance score of the linking web page. A plurality of web links to the destination web page may be assessed to generate a link value score for each web link. A list of relevance rankings of the link value scores ranked from highest to lowest relevance may be compiled. Determining the web links with the highest link value to a destination web page enables that company to determine the most beneficial web links, and thereby establish better business relationships with the web page owners that provide the most beneficial links to the company's web page.

### RELATED APPLICATIONS

This application claims priority to Provisional Application No. 60/838,774 filed Aug. 18, 2006 entitled METHOD AND SYSTEM FOR USING A LINK VALUE by Mary Rose That, the contents of which are incorporated herein by reference in their entirety.

### BACKGROUND

1. Field

The present disclosure relates to a method and system of determining the most relevant web links for a particular web page. More particularly, a system and method of assessing different link values of a plurality of web links to a particular web page is disclosed.

2. General Background

Modern society desires convenience and time-saving mechanisms, making the Internet more and more appealing to the busy lifestyles of modern society. Thus, the strength of the online internet presence of a company is important for a business to determine its strengths and weaknesses. To analyze the effectiveness of its online presence, a company will review and analyze the links from other web pages to its web page.

Currently, there are several techniques to calculate various rankings in a search engine. In a paper entitled “Combating Web Spam with TrustRank” (See Zoltan Gyongyi, Hector Garcia-Molina and Jan Pedersen. Combating Web Spam with TrustRank; Stanford University; 2004), possibilities for implementing the seed selection and discovery of “good” pages are discussed. Their results show techniques that effectively filter out spam for a significant portion of the Internet, thereby discovering those pages deemed to be “good” (i.e., positive links that would drive traffic to the site).

For example, the web page for www.icrossing.com has several links from various webpages. To determine the number of links to this web page, a search query for link:http://www.icrossing.com/ is entered into the Google search engine. A list of approximately 672 different web links to the www.icrossing.com is found.

In theory, the list of web links would be shown in a list by the most important and beneficial links to the web page. The more likely that a user of a linking web page will utilize the web link to leave the linking web page and go to the web page, the more relevant the web link. However, there is no method to determine the most relevant web links.

### SUMMARY

In one aspect of the present disclosure, a method and system of evaluating a value rating for a web link to a destination web page is disclosed. First, a web link to the destination web page is identified, the web link being associated with a linking web page.

In one embodiment, to assess the value of the web link, linking web page data including a total number of links on the linking web page, a number of links to competing web pages on the linking web page, a position of the web link on the linking web page, and a universal significance score for the linking web page is obtained. In some exemplary embodiments, the linking web page data further includes the decay rate of the linking web page. In other embodiments, the universal significance score is Google PageRank.

In an alternative embodiment, to assess the value of the web link destination web page data including a total number of out bound links on the destination web page and a total number of inbound links for the destination web page is obtained.

Finally, a link value score for each web link based on the linking web page data and the destination web page data is generated.

In another aspect, a method of evaluating relevance rankings for web links is disclosed. In this embodiment, a plurality of web links to the destination web page is identified, each web link associated with a linking web page. Then, linking web page data for each linking web page is obtained. Finally, a plurality of link value scores for the plurality of web links is generated. The plurality of link values scores is compiled in a list of the link values scores ranked from highest to lowest relevance.

In still another aspect, a system having a computer readable medium with computer-executable instructions for evaluating a value rating for a web link to a destination web page and compiling a list of link value scores is disclosed.

Other objects, features, and advantages of the present disclosure will become apparent from the subsequent description and the appended claims.

### DRAWINGS

The foregoing aspects and advantages of present disclosure will become more readily apparent and understood with reference to the following detailed description, when taken in conjunction with the accompanying drawings, wherein:

FIG. 1 is a functional block diagram illustrating an exemplary embodiment of a method of determining a value of a linking web page as described in the present disclosure.

FIG. 2 is a functional block diagram illustrating an exemplary embodiment of a system to evaluate a value of a linking web page as described in the present disclosure

The examples set out herein illustrates particular embodiments, and such examples are not intended to be construed as limiting in any manner.

### DETAILED DESCRIPTION

The following description and the drawing illustrate specific embodiments sufficiently to enable those skilled in the art to practice the system and method described. Other embodiments may incorporate structural, logical, process and other changes. Examples merely typify possible variations. Individual functions are optional unless explicitly required, and the sequence of operations may vary, Portions and features of some embodiments may be included in or substituted for those of others.

It should also be understood that the techniques of the disclosed system and method might be implemented using a variety of technologies. For example, the methods described herein may be implemented in software running on a programmable microprocessor, or implemented in hardware utilizing either a combination of microprocessors or other specially designed application specific integrated circuits, programmable logic devices, or various combinations thereof. In particular, the methods described herein may be implemented by a series of computer-executable instructions residing on a storage medium such as a carrier wave, disk drive, or other computer-readable medium.

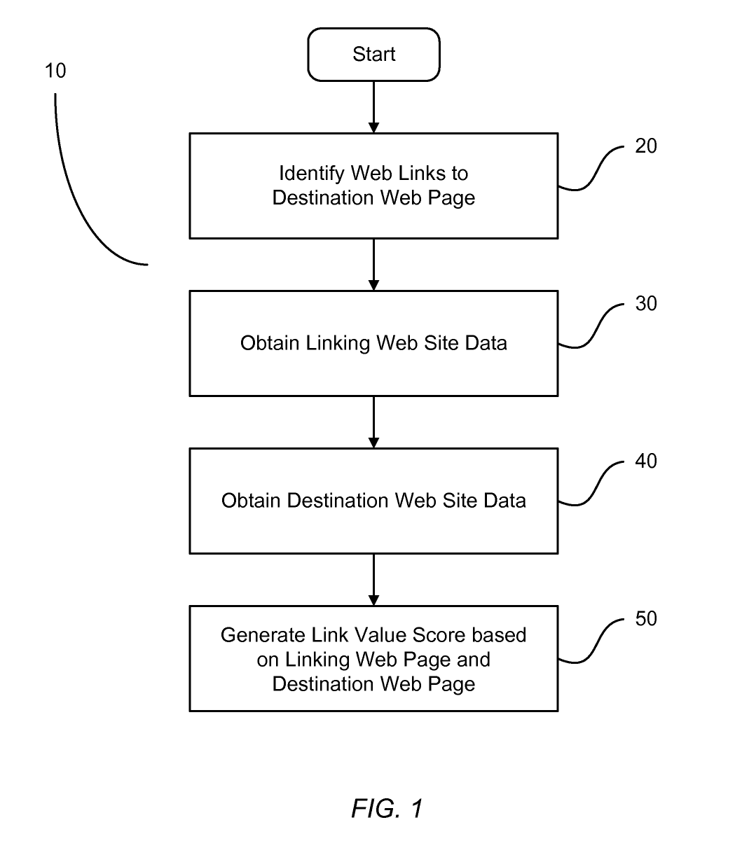

A system and method of determining the value of web links to a web page is disclosed. With reference to FIG. 1, there is a method 10 disclosed wherein the number of links to a web page, referred to herein as the destination web page, is identified 20, and these web links are assessed to help the owner of the destination web page determine the most relevant links.

Then, the web links on the linking web page are analyzed, collecting data on the linking web page 30. For example, the number of links on the linking web page, the number of links that belong to competitors on the linking web page, the position of the destination web page link on the linking web page, the number of links on the linking web page that link to the destination web page, and the significance score for the linking web page are all obtained.

Additionally, the destination web page is analyzed to collecting destination web page data on the linking web page. i(p) represents the number of inbound links to the destination web page; and ω(p) represents the number of outbound links from the destination web page.

For a web page owner or company to analyze the effectives of its web page, the system generates a link value 50 for each web link to the destination web page based on the linking web page and destination web page data.

In an exemplary embodiment, the link value score, V(p), is determined by equation 1, wherein:

$$V ( p ) = {r ( p ) [ {\sum }_{i = 1}^{3} {X}_{i} - {X}_{N} ]}^{- 1} ( 1 - α ) + [ \frac{i ( p )}{i ( p ) + ω ( p )} ] \\ where {\sum }_{i = 1}^{3} {X}_{i} - {X}_{N} \neq 0 , α \neq 1 , i ( p ) \neq 0 , ω ( p ) \neq 0 , r ( p ) > 1 \qquad ( 1 )$$

where X₁ represents the number of links on the linking web page; X₂ represents the number of links that belong to competitors on the linking web page; X₃ represents the position of your link on the linking web page; X_{N} represents the number of links on the linking web page that link to the destination web page; r(p) represents the represents a universal significance score, which, for example, may be the PageRank for the linking web; i(p) the number of inbound links to the destination web page; and ω(p) represents the number of outbound links from the destination web page.

Utilization of the link value algorithm enables a user of the method to calculate the value of a link from each web page to the user's web page. The higher the link value for a particular linking web page, the more beneficial that linking web page is to the user's web page.

In this embodiment, due to the popularity of Google and the importance of the PageRank formula, the link value of a linking web page is calculated in the terms of the significance score of the linked pages obtained from Google. To determine the link value of the various web links, the Google PageRank score r(p) of the linking web page is first identified. The perception behind PageRank is that a web page is more important if several other important web pages link to the web page. Equation 2 represents the Google PageRank score r(p) of a webpage (p):

$$r ( p ) = α \cdot {\sum }_{a : ( q : p ) ∈ ɛ} \frac{r ( p )}{ω ( p )} + ( 1 - α ) \cdot \frac{1}{N} \qquad ( 2 )$$

where p and q are web pages; the set E contains the directed links that connect pages; and N represents the number of pages. Through analysis of this equation, the Google PageRank calculates the score by adding the score that comes from pages that point to p, which is variable, to the other part of the score, which is equal for all Web pages (See Gyongyi, Garcia-Molina, and Pedersen 2004; See also G. Golub and C. Van Loan. Matrix Computation. The Johns Hopkins University Press).

There are several ways that the Google PageRank score formula can be represented (Golub and Van Loan 1996), but, for the purposes of this discussion, only one will be discussed here.

The matrix form of the same equation is represented by Equation 3:

$$r = α T \cdot r + ( 1 - α ) \cdot \frac{1}{N} \cdot {1}_{N} \qquad ( 3 )$$

where T is the transition matrix represented in Equation (4):

$$T ( p , q ) = \{ \begin{matrix}0 & ( q , p ) ∉ ɛ , \\ 1 / ω ( q ) & ( q , p ) ∈ ɛ .\end{matrix} \qquad ( 4 )$$

This equation is used to calculate PageRank scores iteratively (Golub and Van Loan 1996).

Since the link value in this embodiment is calculated in terms of the value of the linked pages obtained from Google, the link value algorithm is consistent with PageRank formula and incorporates values obtained from Google.

In the next step, the links on the linking web page are evaluated. First, X₁ is determined. As stated above, X represents the number of links on the linking web page. When there are fewer links on the linking web page, the more desirable the link value is for that particular web link.

X₂ represents the number of links that belong to competing web pages to the linking web page. Similarly to X₁, the fewer links the competing web pages has on the linking web page, the higher the link value score.

X₃ is a variable that is obtained by finding the position of the link on linking web page as opposed to other links on the page. When the link to the destination web page is higher on the list, a user of the linking web page is more likely to use the link. Thus, the higher position order relative to other links on the linking web page will lead to a decrease in the link value for that particular web link.

X_{N} is a variable that calculates the number of links on the linking web page that are directed to the destination web page. Basically, the more links to the destination web page, the higher the link value.

The portion of the link value algorithm represented by Equation 4 compares proportionally the positive numbers and the negative numbers. The inversion is then placed to situate the relationship between the negative numbers and their value; therefore, the more negative numbers, the lower the link value.

$$\begin{matrix}{[ {\sum }_{i = 1}^{3} {X}_{i} - {X}_{N} ]}^{- 1} & ( 4 ) \\ r ( p ) \cdot {[ {\sum }_{i = 1}^{3} {X}_{i} - {X}_{N} ]}^{- 1} ( 1 - α ) & ( 5 )\end{matrix}$$

Equation 5 represents a portion of the link value algorithm that will result in values in the exemplary range of 0 to 2.5. The algorithm is restricted by

$${\sum }_{i = 1}^{3} {X}_{i} - {X}_{N} \neq 0 ,$$

to avoid calculation errors. It is also necessary to restrict the decay factor to α≠1; otherwise, α would not represent a decay factor. The origin of the decay factor comes from the modification of the original PageRank algorithm. This decay factor limits the effect of rank sinks and guarantees convergence to a unique rank vector (See Taher H. Haveliwala. Efficient Computation of PageRank. Stanford Univeristy, 1999.). In other words, this decay factor helps eliminate bias in the value of the PageRank score.

The final part of the exemplary link value algorithm,

$$[ \frac{i ( p )}{i ( p ) + ω ( p )} ]$$

measures the ratio of inbound links to outbound links. Due to this calculation, the ratio indicates that the more inbound links on the web page, the better the link value. One restriction is that these pages have at least one inbound link. Having no inbound links and no outbound links will obviously result in a calculation error, and, if the webpage has no inbound or outbound links, there is no need to calculate link value.

The variables utilized in the calculation of the link value for each linking web page may be determined either manually by an individual analyzing the web page or by a computer program automated to determine these variables. In an exemplary embodiment, an individual manually looks up the variables to determine the link value. The variables can be easily discovered from Google or from the HTML code of the linking web page.

In another embodiment, computer-executable instructions residing on a storage medium such as a disk drive, or other computer-readable medium will compile the necessary data and calculate the link value score. The variables can be discovered by a counting process or through Google or HTML code.

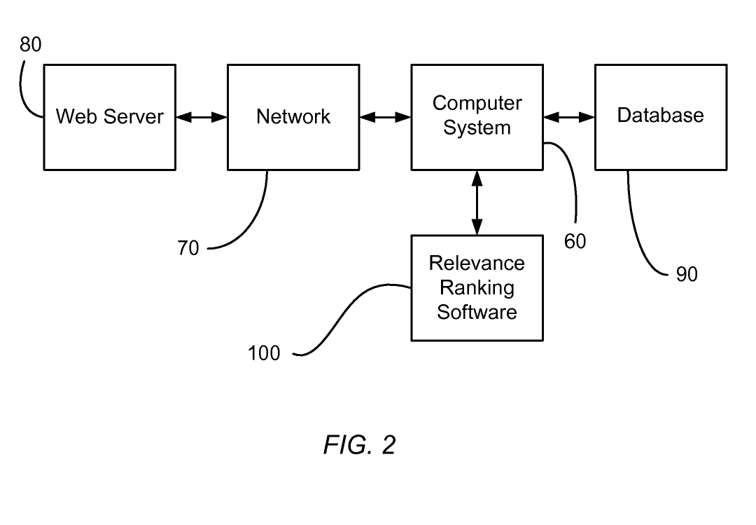

In a further exemplary embodiment, a computer system executes software and process information to evaluate a value rating for a web link to a destination web page using values obtained the web link. The computer system 100 generally may take many embodiments, including, for example, a plurality of processing units networked together to function as a integral entity or to a single computer operational in a stand-alone environment. Computer systems may include a variety of components and devices such as a processor, memory, data storage, data communications buses, and a network communications device. With reference to FIG. 2, the computer system 60 is connected to a network 70, for example, the Internet.

A web server 80 receives and processes search queries from a user, or access device 100, attempting to locate information on the network 70. The web server 80 is, for example, a search engine which is a remotely accessible software program that lets a user perform searches including but not limited to searches for web links to a destination web page on the network 70. In exemplary embodiments, the computer system may include a database 90 having indexes of web links and other relevant data about these web links through the network 70. In response to a search query, the web server 80 identifies a plurality of web links to be analyzed.

Utilizing the method disclosed herein, the web links are processed by a relevance ranking software 100 as described herein. The relevance ranking software 100 generates a relevance rank for each web link such that the most relevant web links are displayed based on the relevance rank. The relevance ranking of a web page is based on data on the links on the linking web page, the relevance of the linking web page, and the links to and from the destination web page.

The system and method disclosed herein permits a company to determine whether a particular link from a web page is beneficial. Additionally, the web page owner can determine if the linking web page is helpful, harmful, or neutral.

In exemplary embodiments, once the analysis has been performed and the link value for each web page has been generated, a list is created with the most important links as defined by the link value score

By way of example, the iCrossing web page at www.icrossing.com has been analyzed utilizing the link value determining method as the destination web page of the present disclosure. To determine the amount of links to a web page, a search query for link:http://www.icrossing.com/ is entered into the Google search engine. By utilizing Google's link functionality, it was determined that www.icrossing.com has a total of 672 incoming links and 182 outbound links. Outbound links from each web page is determined from the source code.

The first link that appears the search query results is from the linking web page www.searchenginewatch.com/searchday/article. php/3412721, hereinafter called Linking Web page A. This is the first link visible on the Google link search query, and thus should hopefully be the most important link for the iCrossing company. Using the Link Value algorithm, the link value of the Linking Web page A is found to be about 0.8. Table 1 shows the variables utilized in the calculation and the resulting link value. These values are easily obtained from Google or from the HTML code of the linking web page.

TABLE 1
Link Value Assessment for Linking Web page A

| Algorithm Variable | Value |
|---|---|
| Google PageRank - r(p) | 7 |
| Number of Links on Linking Web Page - X₁ | 153 |
| Number of Links to Competitor Web Pages - X₂ | 1 |
| Position of iCrossing Link - X₃ | 31 |
| Number of Links to iCrossing Web page - X_{N} | 1 |
| Number of Inbound Links to iCrossing Web page - i(p) | 672 |
| Number of Inbound Links to iCrossing Web page - ω(p) | 184 |
| Decay Factor - α | 0.85 |
| Link Value V(p) | 0.8 |

By means of comparison, another linking web page from the Google search query results is evaluated utilizing the link value assessment of the present disclosure. The linking web page www.reversedirectmarketing.com/archives/00000029.htm, hereinafter referred to as Linking Web page B, is the ninth link visible on the Google link search query, and thus is typically a less important link for the crossing company. Using the Link Value algorithm, the link value of the Linking Web page B is found to be about 0.82. Table 2 shows the variables utilized in the calculation and the resulting link value.

TABLE 2
Link Value Assessment for Linking Web Page B

| Algorithm Variable | Value |
|---|---|
| Google PageRank - r(p) | 7 |
| Number of Links on Linking Web page - X₁ | 32 |
| Number of Links to Competitor Web pages - X₂ | 0 |
| Position of iCrossing Link - X₃ | 1 |
| Number of Links to iCrossing Web page - X_{N} | 3 |
| Number of Inbound Links to iCrossing Web page - i(p) | 672 |
| Number of Inbound Links to iCrossing Web page - ω(p) | 184 |
| Decay Factor - α | 0.85 |
| Link Value V(p) | 0.82 |

As illustrated in the above tables, in the exemplary implementation of the disclosed method, linking web page B has a higher link value than Linking Web Page A. As a result, a service company knows that the link providing by linking Web Page B has a more important web page link. The service company may then work with the company owning Web Page B to maintain the strong relationship. The service company could also work with the owner of Web Page A to strengthen its relationship.

To better understand its online presence, the owner of a destination web page may perform a similar analysis on each web link linking to its web page to determine the most relevant web links. In exemplary embodiments, a list of the link values of each web link to the destination web page would be compiled. For example, the web links may be compiled in a list with the highest relevance, or highest link value, to the lowest link value. The owner of the destination web page may utilize the listing of web links by link values to determine the most relevant web links to its web page.

All publications, including patents, published patent applications, scientific or trade publications and the like, cited in this specification are hereby incorporated herein by reference in their entirety.

While the above description contains many particulars, these should not be considered limitations on the scope of the disclosure, but rather a demonstration of embodiments thereof. The system and method disclosed herein include any combination of the different species or embodiments disclosed. Accordingly, it is not intended that the scope of the disclosure in any way be limited by the above description. The various elements of the claims and claims themselves may be combined any combination, in accordance with the teachings of the present disclosure, which includes the claims.

1. A method of evaluating a value rating for a web link to a destination web page comprising:
identifying a web link to the destination web page, the web link associated with a linking web page;
obtaining linking web page data including a total number of links on the linking web page and a position of the web link on the linking web page;
obtaining destination web page data including a total number of out bound links on the destination web page and a total number of inbound links for the destination web page; and
generating a link value score for each web link based on the linking web page data and the destination web page data.

2. The method of claim 1 wherein the linking web page data further includes a number of links to competing web pages on the linking web page.

3. The method of claim 1 wherein the linking web page data further includes a universal significance score for the linking web page.

4. The method of claim 1 wherein the linking web page data further includes the decay rate of the linking web page.

5. The method of claim 1 further comprising compiling a relevance ranking list of web links based on the link value score.

6. The method of claim 3 wherein the universal significance score is Google PageRank.

7. A method of evaluating relevance rankings for web links to a destination web page comprising:
identifying a plurality of web links to the destination web page, each web link associated with a linking web page;
obtaining linking web page data for each linking web page including a total number of links on the linking web page, a number of links to competing web pages on the linking web page, a position of the web link on the linking web page, and a universal significance score for the linking web page;
obtaining destination web page data including a total number of out bound links on the destination web page and a total number of inbound links for the destination web page; and
generating a plurality of link value scores for the plurality of web links.

8. The method claim 7 further comprising compiling a list of the link values scores ranked from highest to lowest relevance.

9. The method of claim 7 wherein fewer links on the linking web page results in a higher link value score.

10. The method of claim 7 wherein a higher link position order on the linking web page results in a lower link value score.

11. The method of claim 7 wherein fewer links to competitor web pages on the linking web page results in a higher link value score.

12. The method of claim 7 wherein more links to the destination web page on the linking web page results in a higher link score.

13. The method of claim 7 wherein the linking web page data further includes the decay rate of the linking web page.

14. The method of claim 7 wherein the universal significance score for the linking web page is Google PageRank.

15. A computer readable medium with computer-executable instructions for evaluating a value rating for a web link to a destination web page comprising:
identifying a web link to the destination web page, the web link associated with a linking web page;
obtaining linking web page data including a total number of links on the linking web page, a number of links to competing web pages on the linking web page, a position of the web link on the linking web page, and a universal significance score for the linking web page;
obtaining destination web page data including a total number of out bound links on the destination web page and a total number of inbound links for the destination web page; and
generating a link value score for each web link based on the linking web page data and the destination web page data.

16. The medium of claim 15 further comprising identifying a plurality of web links to the destination web page and generating a link value score for each web link.

17. The medium of claim 16 further comprising compiling a list of relevance rankings of the link values scores ranked from highest to lowest relevance.

18. The medium of claim 16 wherein fewer links on the linking web page results in a higher link value score.

19. The medium of claim 16 wherein a higher link position order on the linking web page results in a lower link value score.

20. The medium of claim 16 wherein fewer links to competitor web pages on the linking web page results in a higher link value score.

21. The medium of claim 16 wherein more links to the destination web page on the linking web page results in a higher link score.

22. A system comprising:
a server executing software to evaluate a value rating for a web link from a linking web page using data obtained about the linking web page.

23. The system of claim 22 further comprising a database in communication with the server, wherein the database stores data about the linking web page.
